(19) United States
(12) Patent Application Publication
(10) Pub. No.: US 2007/0214762 A1
(43) Pub. Date: Sep. 20, 2007

(54) Walk behind sliding gear clutch

(75) Inventors: Lawrence R. Folsom, Rensselaer, NY (US); Clive Tucker, Lenox, MA (US); Brian P. Lyster, Underhill, VT (US); Douglas W. Bell, Mattoon, IL (US); Michael L. Bennett, Sullivan, IL (US)

Correspondence Address: NEAL, GERBER, & EISENBERG, SUITE 2200, 2 NORTH LASALLE STREET, CHICAGO, IL, 60602, US

(73) Assignee: Hydro-Gear Limited Partnership, Sullivan, IL (US)

(21) Appl. No.: 11/191,653

(22) Filed: Jul. 28, 2005

Related U.S. Application Data
(60) Provisional application No. 60/592,807, filed on Jul. 30, 2004.

(51) Int. Cl. A01D 69/10

(52) U.S. Cl. 56/11.3

(57) ABSTRACT

A drive apparatus having an axle and drive gear for the axle mounted within a housing, the drive gear capable of being drivingly coupled to a worm gear formed on an input shaft. An actuator extending into the housing and cooperating with the input shaft, where the actuator may rotate the input shaft about a point along the longitudinal axis of the input shaft between the first and second ends thereof to move the worm gear from a first position where it is engaged to and drives the drive gear and a second position where the worm gear does not contact the drive gear.

### CROSS REFERENCE

This application is claiming the priority of U.S. Provisional Patent Application assigned Ser. No. 60/592,807 filed on Jul. 30, 2004, the terms of which are incorporated herein by reference.

### BACKGROUND OF THE INVENTION

This invention relates to drive devices that require power to be coupled and uncoupled in a power train, such as in self-propelled walk-behind mechanisms. Known designs to create a coupling apparatus, such as a clutch on an input pulley or clutches on a driven axle shaft, are generally costly and/or require excessive space. Thus, there is a need for a compact, cost effective clutch for use in a power train.

### SUMMARY OF THE INVENTION

This invention relates to a shaft clutch used in a vehicle or other apparatus where it is desired to disengage the drive from the axle in a simple low-cost manner. This invention provides a transmission drive where the axle drive gear can be moved by means of a fork between a first position where it is engaged with the input drive shaft and a second position where it is disengaged from the input drive shaft. This invention is depicted in connection with a walk behind mower, although it will be understood that this invention may also be used with other applications.

A better understanding of the objects, advantages, features, properties and relationships of the invention will be obtained from the following detailed description and accompanying drawings which set forth illustrative embodiments that are indicative of the various ways in which the principles of the invention may be employed.

### BRIEF DESCRIPTION OF THE DRAWINGS

FIG. 1 is a side elevational view of an exemplary vehicle, namely a walk behind mower, incorporating the present invention, with certain elements removed for clarity.

FIG. 2 is an external perspective view of a transmission incorporating the present invention.

FIG. 3 is an internal isometric view of certain components of the transmission shown in FIG. 2, with the drive apparatus in the disengaged position.

FIG. 4 is an internal isometric view of certain components of the transmission shown in FIG. 2, with the drive apparatus in the disengaged position.

FIG. 5 is an additional internal isometric view of certain components of the transmission shown in FIG. 2, with the drive apparatus in the engaged position.

FIG. 6 is an internal isometric view of a second embodiment of certain components of a transmission such as is shown in FIG. 2, with the drive apparatus in the engaged position.

FIG. 7 is an additional internal isometric view of the second embodiment shown in FIG. 6, with the drive apparatus in the engaged position.

FIG. 8 is an additional internal isometric view of the second embodiment shown in FIG. 6, with the drive apparatus in the disengaged position.

FIG. 9 is an internal isometric view of a portion of an axle shaft, with a first embodiment of an engagement pin configuration.

FIG. 10 is an internal isometric view of a portion of an axle shaft, with a second alternative embodiment of an engagement pin configuration.

FIG. 11 is a side elevational view of certain internal components of the embodiment of FIG. 6.

FIG. 12 is a partial sectional view along the line 12-12 in FIG. 11.

FIG. 13 is an elevational view of a spur gear embodiment with a gear tooth profile modified in accordance with one embodiment of the present invention.

FIG. 14 is an internal plan view of certain components of a transaxle in accordance with a further embodiment of this invention in an engaged position, with the input shaft rotating in a first direction.

FIG. 15 is an internal plan view of the components shown in FIG. 14, in an engaged position, with the input shaft rotating in a second direction.

FIG. 16 is an internal plan view similar to that of FIG. 14, with the components arranged to permit rotation in the opposite direction from that shown in FIG. 14.

FIG. 17 is an internal plan view similar to that of FIG. 15, with the components arranged to permit rotation in the opposite direction from that shown in FIG. 15.

### DETAILED DESCRIPTION OF THE INVENTION

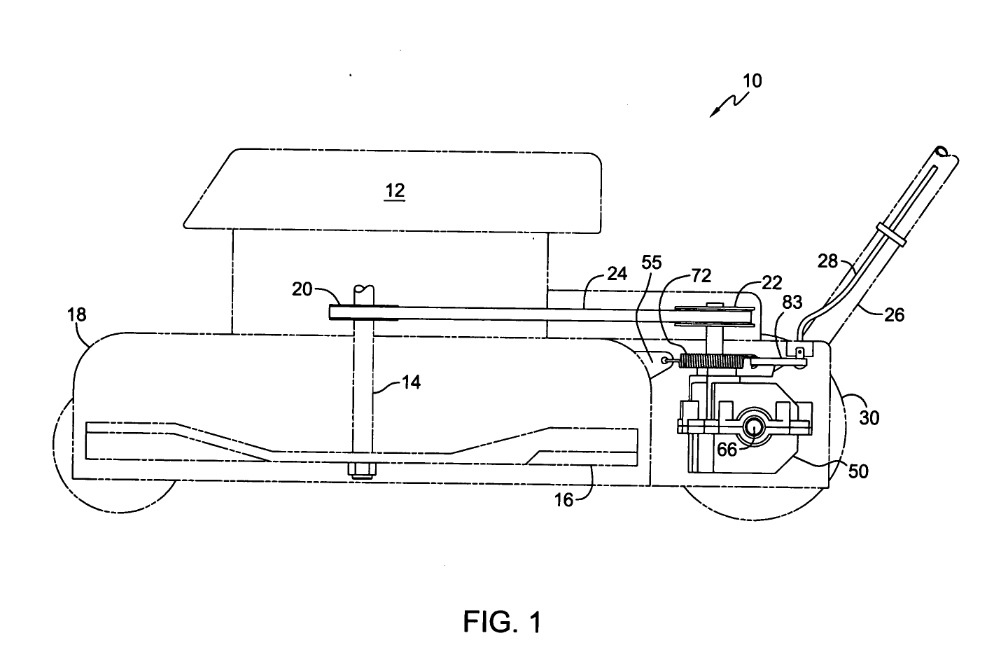

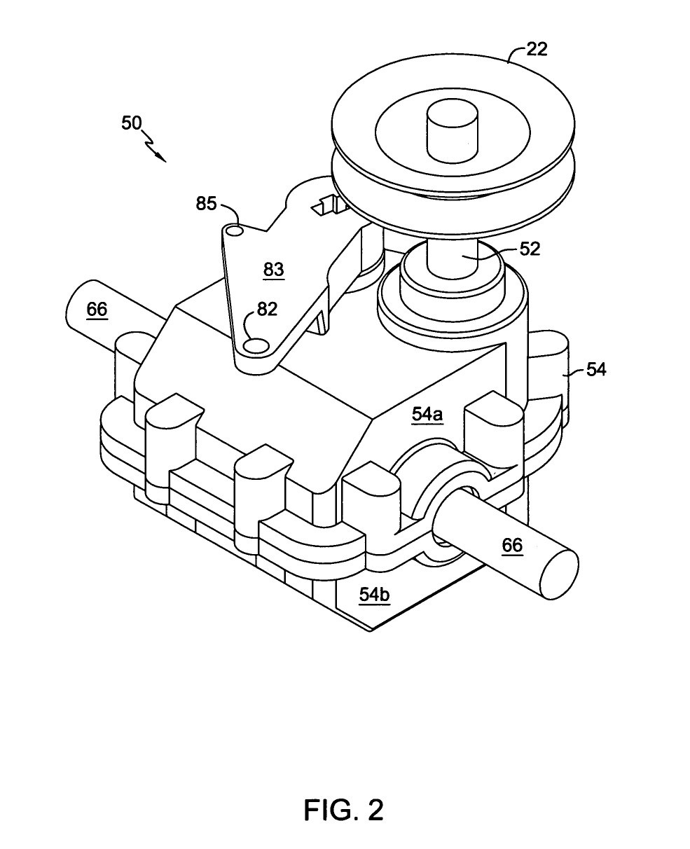

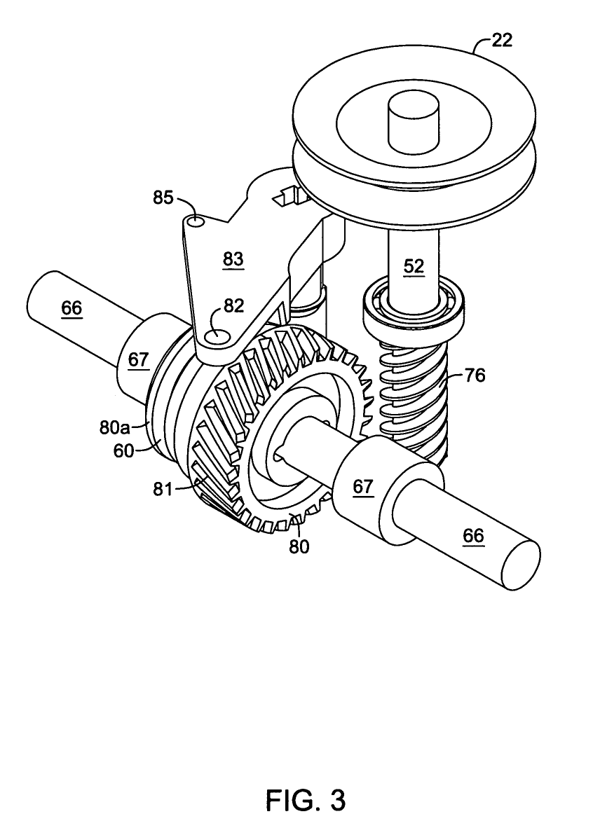

FIG. 1 shows an exemplary vehicle, namely a walk behind mower, incorporating the present invention, and a first embodiment of transaxle 50 is shown in FIGS. 2 and 3. Certain elements, such as one of the drive wheels 30, are not depicted in FIG. 1 to assist in understanding the invention. As will be understood by a person of ordinary skill, while the description herein is in the context of a walk behind mower 10, the invention can be employed in a variety of applications using a clutch or requiring an apparatus to engage or disengage a rotational drive. Thus, the description of the specific application in this context is for illustrative purposes only and should not be construed as limiting.

Mower 10 comprises a prime mover 12 that may be of a variety of known types such as an electric or internal combustion engine. In addition, prime mover 12 has an output shaft 14 that powers a cutting blade 16 positioned within a deck 18. Output shaft 14 may be directly coupled to transaxle 50 or, as shown in FIG. 1, output shaft 14 and transaxle 50 may be coupled by using a belt 24 mounted on pulleys 20 and 22. For transferring rotational force from prime mover 12 to transaxle 50, pulley 22 may be drivingly mated to transaxle input shaft 52. To operate mower 10, controls for engine 12 and transaxle 50 may be mounted on handle 26. Other controls, such as a blade engagement control or electric start switch, may also be provided depending on the application needs.

To form a transaxle housing 54, two housing portions 54a and 54b may be joined along a surface that is generally parallel to axle shaft 66. It should be appreciated, however, that other housing configurations, such as ones with joining surfaces that are perpendicular to axle shaft 66, are also compatible with the invention disclosed herein. Housing portions 54A and 54B may be joined to each other in one of a variety of known methods such as with fasteners, by sonic welding if the housing is plastic or with an adhesive. Housing 54 forms an internal sump that may hold a lubricant such as grease.

For driving mower 10, axle shaft 66 may provided. While it is preferred that for driving mower 10 axle shaft 66 is mounted in and extends out of opposite sides of housing 54, this invention may also be used with an application where an axle shaft extends out of only one side of housing 54. It should be understood by those with skill in the art that axle shaft 66 may form one axle shaft for driving mower 10 or axle shaft 66 may be one of a pair of independent axle shafts for driving mower 10. For supporting axle shaft 66 in housing 54, bearings 67 may be provided. Bearings 67 as shown are friction bearings such as bronze, but they may be needle bearings, ball bearings, or other types of friction bearings or busings. Axle 66 may also run directly on housing 54, depending on the required bending moments transmitted through axle 66, the type of lubrication, the material of housing 54 and the surface area in contact with axle 66.

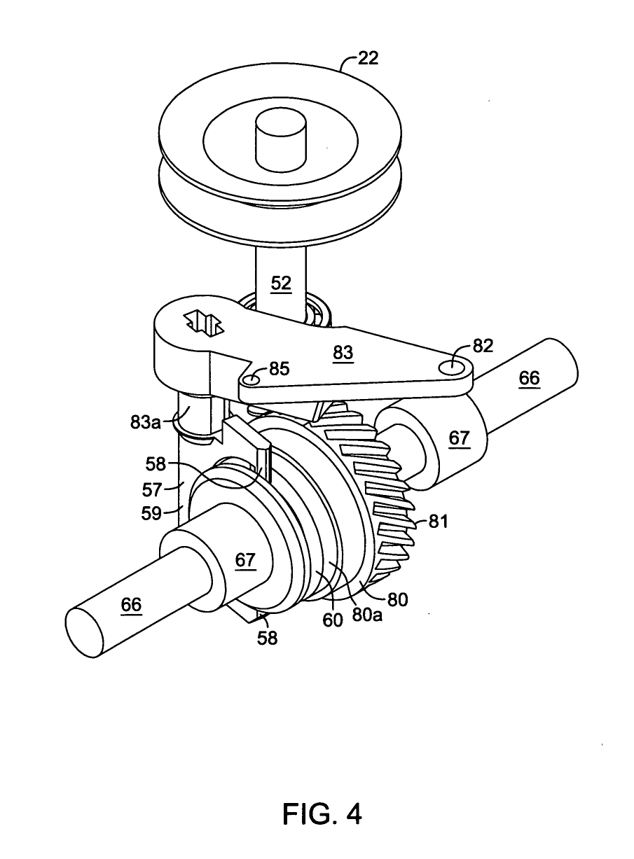

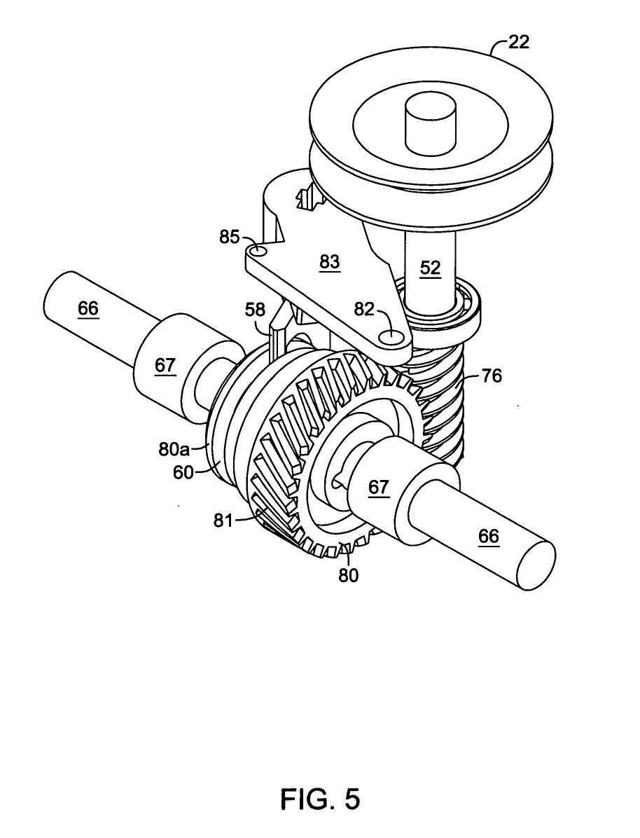

As shown in FIG. 5, which shows transaxle 50 in an engaged position, for driving axle shaft 66, teeth 81 of gear 80 are drivingly coupled to the teeth of worm gear 76, which are formed on transaxle input shaft 52. Therefore, when the clutch assembly described herein is engaged, the rotation of worm gear 76 will cause gear 80 to rotate, causing axle shaft 66 and wheels 30 to rotate, propelling mower 10. Operation of this invention can be seen most clearly by comparing FIG. 5, which shows input shaft 52 in a first position whereby worm gear 76 is engaged to teeth 81 of spur gear 80, and FIGS. 3 and 4 where gear 80 is disengaged from input shaft 52.

To actuate transaxle 50, an actuator assembly may be provided. The actuator assembly may further comprise an actuator arm 83, which may be mounted outside housing 54. To move actuator arm 83, actuator arm 83 may be coupled to a vehicle control via cables 28 or other known means. Cables 28 may be attached to hole 82 in actuator arm 83. Actuator arm 83 includes an integrally formed sleeve portion 83a that snaps into upper housing 54a through a hole (not shown) and serves as a bearing surface against housing 54a. Actuator arm 83 is also connected to a fork 57. Fork 57 is mounted in housing 54 and has a pair of tines 58 at opposite ends of a main body portion 59 of fork 57. Tines 58, which may be integral with fork 57 or separate pieces affixed to fork 57, are mounted in a slot 60 formed in extension 80a of gear 80. While extension 80a is preferably formed integrally with gear 80 for easier assembly and reduced cost, extension 80a could be formed separately from gear 80 and then affixed to gear 80 by a fastener or other method that would cause movement of extension 80a along axle shaft 66 to move gear 80 along axle shaft 66. As can be seen in these figures, rotation of actuator arm 83 causes fork 57 to rotate, moving gear 80 in an axial direction along the longitudinal axis of axle 66. More specifically, rotation of actuator arm 83 in the counter-clockwise direction moves spur gear 80 from the disengaged position shown in FIGS. 3 and 4, i.e., where no force is transmitted from input shaft 52 to axle 66, to the engaged position shown in FIG. 5.

To bias input shaft 52 toward the disengaged position, a spring 72 may be secured to an attachment hole 85 on actuator arm 83 and bracket 55 on mower 10, or a similar fixed member. Thus, the user would rotate actuator arm 83 in a counter-clockwise direction to place transaxle 50 into drive mode; if the user releases the control associated with actuator arm 83, spring 72 would act to rotate actuator arm in a clockwise direction and input shaft 52 would assume a disengaged position.

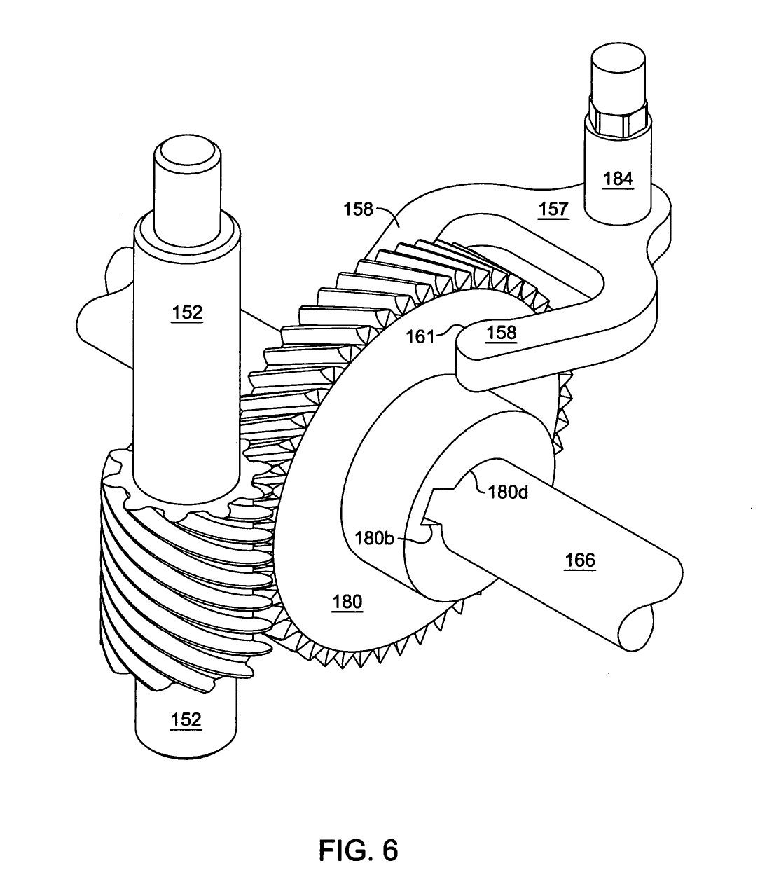

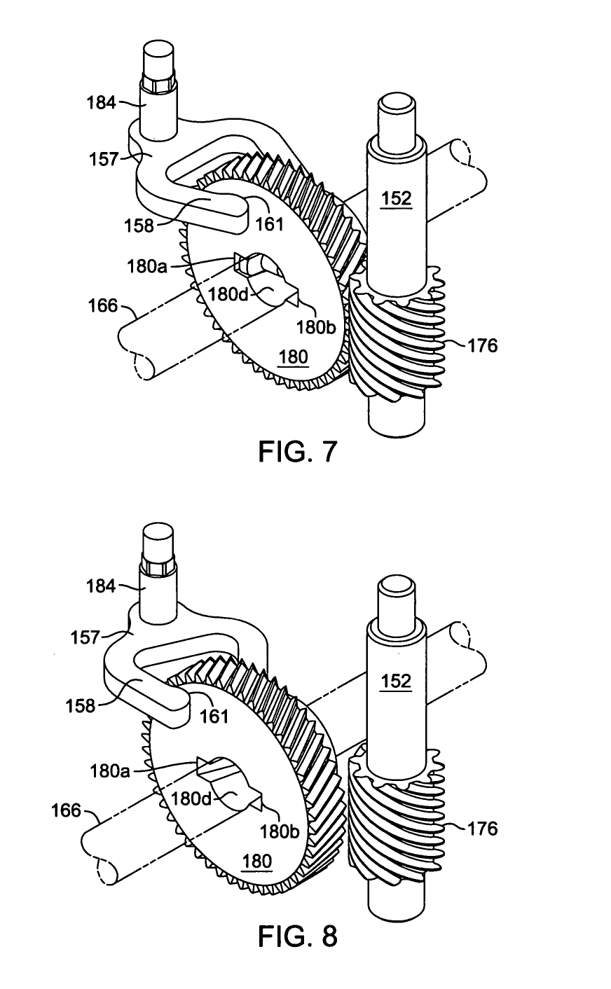

A second embodiment of the internal components of a transmission in accordance with this invention is shown in FIGS. 6-8; the external elements of this embodiment may be substantially identical to those previously described and are therefore not shown for clarity. In this embodiment, actuator shaft 184 comprises a first end extending out of the housing (not shown) and a second end operatively engaged to fork 157. Fork 157 includes a pair of tines 158, preferable integrally formed therewith and located proximate the sides of gear 180. Gear 180 is moved into and out of engagement with gear teeth 176 formed on input shaft 152 by the action of rounded portions 161 formed on tines 158. The use of rounded portions 161 on the ends of tines 158 promotes smooth shifting between the positions shown in FIGS. 7 and 8.

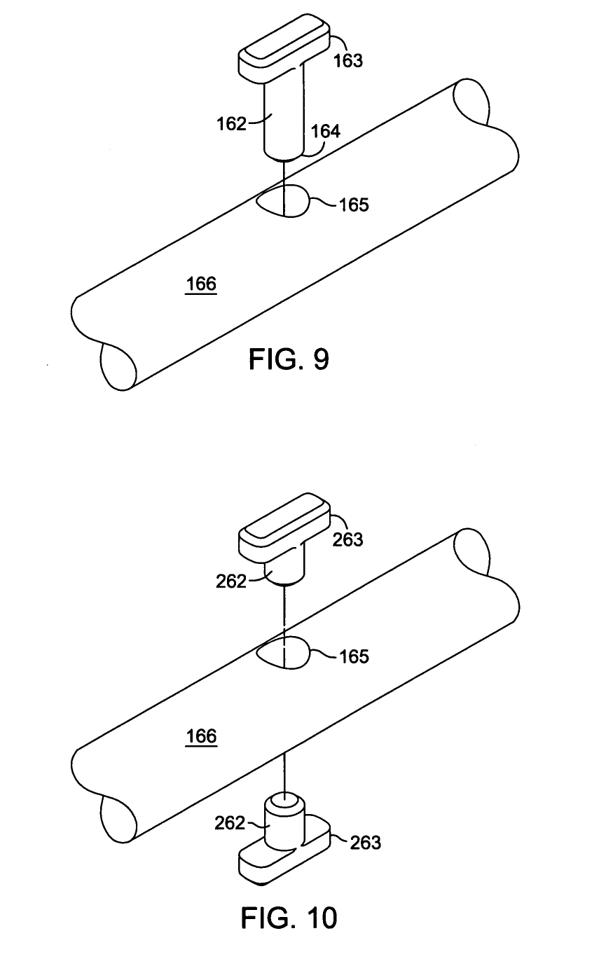

FIG. 9 shows one embodiment of a pin 162 used to engage axle shaft 166 with gear 180. In the embodiment shown in FIG. 7, gear 180 includes spiral grooves 180a and 180b formed opposite thereto within opening 180d to receive axle shaft 166. Pin 162 extends through opening 165 in shaft 166 and has a head portion 163 that engages with groove 180a, and an end 164 formed opposite head 163 to engage groove 180b. Having contact between head portion 163 and groove 180a as well as end portion 164 and groove 180b increases the ability of gear 180 to transmit torque to shaft 166. In some applications, end portion 164 need not be in contact with groove 180b. Also, though head portion 163 is shown as being generally rectangular, the configuration is dependent on the amount of torque being transmitted from gear teeth 176 to axle shaft 166.

FIG. 10 depicts an alternative embodiment using two pins 262, each having a head 263 to engage either groove 180a or 180b. Similar to the description of the previous embodiment, in some applications one pin 262 may be eliminated, depending on the torque required to be transmitted from gear teeth 176 to axle shaft 166.

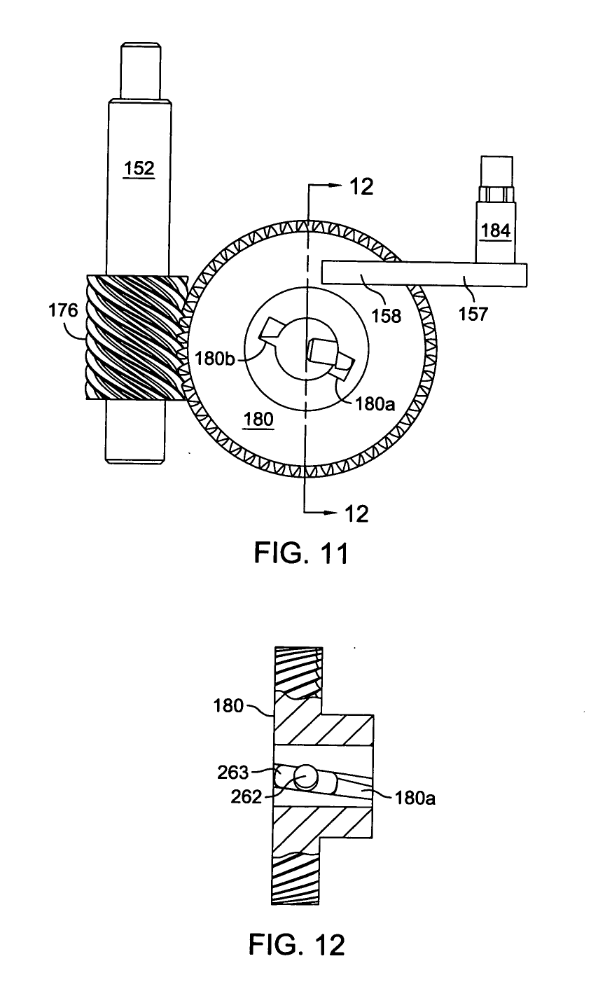

When grooves 180a and 180b are formed as a spiral, as can be seen in FIGS. 11 and 12, as fork 157 moves gear 180 along axle shaft 166 it also causes gear 180 to rotate slightly in a direction that is away from engagement with worm gear teeth 176. Though the amount of such rotation and the corresponding disengagement is small, it reduces the force keeping gear 180 engaged with gear teeth 176, thus making it easier to move gear 180 from the engaged position to the disengaged position.

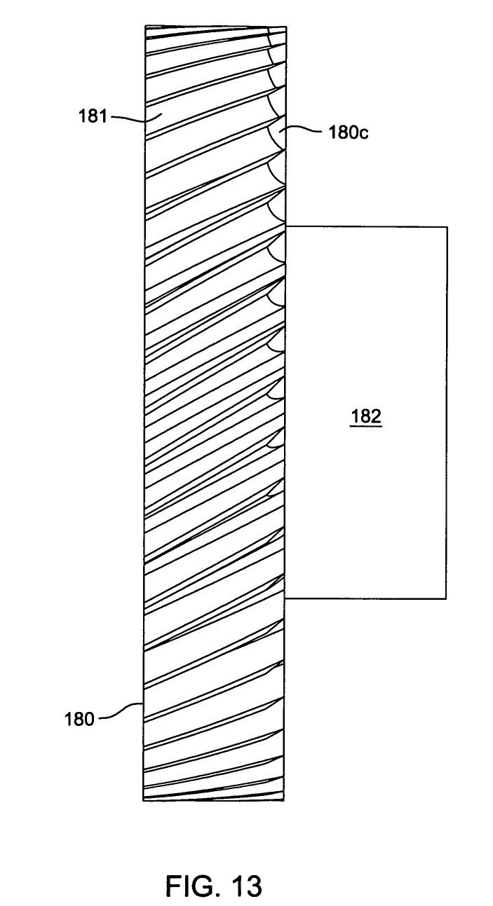

In certain applications, it may be preferable to use a modified spur gear to reduce the risk of binding between the spur gear and the worm gear. In a typical spur gear, the edges of the gear teeth are relatively sharp and have a certain width, and when moving the spur gear into engagement with the worm gear teeth, there is a risk of the two gears binding, increasing the difficulty of engagement. To decrease the risk of binding the edges of the spur gear teeth may be modified as shown in FIG. 13, in which a chamfer 180c has been added to one edge of gear teeth 181. Chamfer 180c has been cut to remove a portion of the end of the gear teeth 181 so that as gear 180 is moved to engage with worm gear teeth 176, chamfer 180c will provide additional clearance to permit gear teeth 181 to move into engagement with worm gear teeth 176.

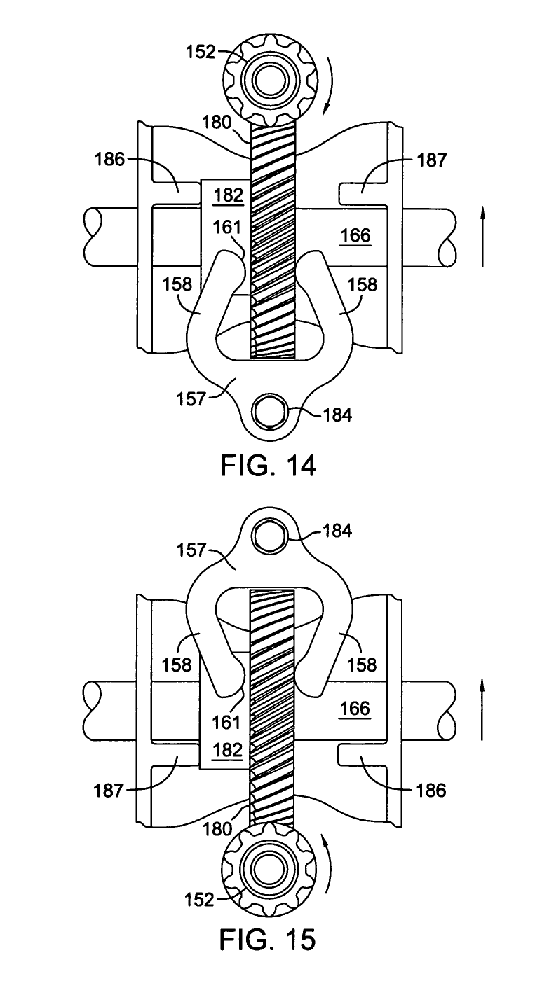

A further benefit of this invention is that in certain embodiments, the same components may be installed slightly differently in the housing to accommodate either clockwise or counterclockwise rotation of the input shaft. This optional feature may be accomplished by providing at least two internal projections or similar features within the housing and generally adjacent the drive gear. In the embodiments shown in FIGS. 14-17, a pair of housing features 186 and 187 is provided, each extending inwardly towards opposite sides of gear 180 or 280. As shown in FIG. 14, gear 180 also has a shoulder 182 integrally formed thereon. When input shaft 152 rotates in a clockwise direction when seen from an end of input shaft 152, the interaction of worm gear teeth 176 with gear teeth 181 causes gear 180 to be biased toward housing feature 186. Locating input shaft 152 at the middle of the space between feature 186 and feature 187 permits gear 180 to be positioned with shoulder 182 adjacent to either housing feature 186 or housing feature 187. With shoulder 182 positioned adjacent to housing feature 186 and input shaft 152 rotated in a clockwise direction, the forward direction will be as the arrow adjacent axle shaft 166 indicates in FIG. 14. With shoulder 182 positioned adjacent to housing feature 187, and the transaxle elements oriented as shown in FIG. 15, and with input shaft 152 rotated in a counterclockwise direction, the forward direction will be as the arrow adjacent axle shaft 166 indicates in FIG. 15. Thus, by using the same components in a slightly different configuration, both clockwise and counterclockwise engine output shaft operation may be accommodated by this design, which increases flexibility and reduces costs.

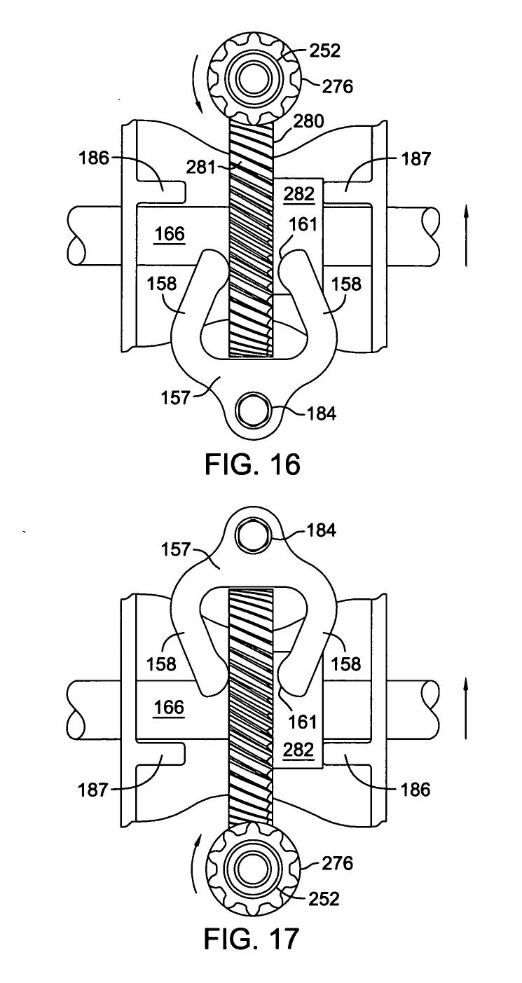

By reversing the angle of worm gear teeth 276 and spur gear teeth 281, counterclockwise rotation of input shaft 252 will provide a forward direction as indicated by the arrow adjacent axle shaft 166 in FIG. 16, while permitting shoulder 282 to be adjacent to housing feature 187. Similar to the previously described engagement of worm gear teeth 176 and spur gear teeth 181, the direction of rotation of input shaft 252 in combination with the interaction of gear teeth 276 and gear teeth 281 will bias gear 280 into the position shown in FIG. 16. Similarly, moving shoulder 282 from the position shown in FIG. 16 to the position shown in FIG. 17 will permit the use of a clockwise input to achieve the forward direction, while biasing gear 280 toward housing feature 186.

In the foregoing discussion of the various figures above, it will be obvious that the shoulders described may either be integrally formed or may be a separate element that functions as a spacer. Also obvious is that the housing features that interact with the shoulders may be in a variety of configurations, with but one of the varieties shown. Other features may yield similar benefits, such as having the stop features formed as part of the axle shaft. Also, a person of skill in the art will recognize that while the features that permit both clockwise and counterclockwise engine input are advantageous, these features are but one aspect of the invention and other aspects of the invention will function without the need for the symmetry described to achieve such flexibility.

While specific embodiments of the invention have been described in detail, it will be appreciated by those skilled in the art that various modifications and alternatives to those details could be developed in light of the overall teachings of the disclosure. Accordingly, the particular arrangements of the input shaft, clutch mechanism, worm gear, etc. disclosed are meant to be illustrative only and not limiting as to the scope of the invention which is to be given the full breadth of the appended claims and any equivalents thereof.

1. A drive apparatus comprising:
a housing having an axle mounted therein, where the axle is coupled to and driven by a drive gear;
an input shaft having a first end driven by a prime mover and a second end extending into the housing;
a worm gear driven by the input shaft; and
an actuator extending into the housing and engaged to the drive gear, whereby the actuator slides the drive gear along the longitudinal axis of the axle to move the drive gear between a first position where it is coupled to and driven by the input shaft, and a second position where the drive gear is not coupled to the input shaft.

2. A drive apparatus as set forth in claim 1, wherein the worm gear is integrally formed on the input shaft.

3. A drive apparatus as set forth in claim 1, wherein the actuator comprises a fork mounted in the housing and an arm engaged to the fork and extending outside the housing.

4. A drive apparatus as set forth in claim 1, wherein the actuator is biased to position the drive gear in the second position.

5. A drive apparatus as set forth in claim 4, further comprising a spring which acts to bias the actuator.

6. A drive apparatus as set forth in claim 1, further comprising a pulley mounted on the first end of the input shaft to engage a prime mover.

7. A drive apparatus as set forth in claim 1, wherein the actuator engages a groove formed into the drive gear.

8. A drive apparatus as set forth in claim 7, where a fork forming part of the actuator engages the groove.

9. A drive apparatus as set forth in claim 1, further comprising a chamfer added to the teeth of the drive gear.

10. A clutch mechanism for a drive apparatus having an axle driven by an output gear mounted in a housing and an input shaft, the clutch mechanism comprising:
a worm gear mounted on the input shaft; and
means for selectively moving the output gear along the longitudinal axis of the axle between a first position where the output gear is engaged to and driven by the worm gear and a second position where the output gear is disengaged from the worm gear.

11. A walk behind mechanism having a drive apparatus including a clutch mechanism comprising:
a housing in which is mounted an input shaft;
a worm gear mounted on the input shaft, the worm gear being drivingly coupled to a drive gear;
an axle shaft driven by the drive gear; and
an actuator positioned within the housing, wherein the actuator is in contact with the drive gear to move the drive gear into or out of engagement with the worm gear.

12. A walk behind mechanism as set forth in claim 11, further comprising a mower deck.

13. A walk behind mechanism as set forth in claim 11, wherein the actuator is biased to a position where the drive gear is out of engagement with the worm gear.

14. A walk behind mechanism as set forth in claim 13, wherein the biasing action is provided by a spring attached to the actuator.

15. A walk behind mechanism as set forth in claim 14, wherein the spring is attached between an external arm portion of the actuator and a bracket located on the walk behind mechanism.

16. A drive apparatus comprising:
a housing having an axle mounted therein;
an input gear driven by an input shaft;
a drive gear drivingly coupled to and slidable along the axle shaft toward or away from the input gear; and
an actuator extending into the housing and cooperating with the drive gear, whereby the actuator moves the drive gear along the axis of the axle to move between a first position where it is coupled to and driven by the input gear and a second position where the drive gear is disengaged from the input gear.

17. A drive apparatus as set forth in claim 16, wherein the input gear is a worm gear.

18. A drive apparatus as set forth in claim 16, wherein the actuator engages the drive gear in a slot formed in the drive gear.

19. A drive apparatus as set forth in claim 18, wherein the slot is formed in a portion of the drive gear extending from a side of the drive gear.

20. A drive apparatus as set forth in claim 18, wherein the actuator engages the slot by way of a fork.

21. A drive apparatus as set forth in claim 16, wherein the drive gear is biased to assume the second position.

22. A drive apparatus as set forth in claim 21, wherein the biasing action is provided by a spring attached to the actuator.

23. A drive apparatus as set forth in claim 22, wherein the spring is attached to an external portion of the actuator and a bracket located on a walk behind mechanism in which the drive apparatus is mounted.

24. A drive apparatus as set forth in claim 16, further comprising an opening formed in the drive gear, wherein the axle shaft extends through the opening, a pair of spiral grooves formed in the opening, and a pin extending through the axle and engaging the spiral grooves.
